(19) United States
(12) Patent Application Publication
(10) Pub. No.: US 2023/0407550 A1
(43) Pub. Date: Dec. 21, 2023

(54) CLOTHES DRYER

(71) Applicant: MAIKOLOGY DESIGNATED ACTIVITY COMPANY, Co. Dublin (IE)

(72) Inventors: Sean TOOMEY, Co. Dublin (IE); Patricia MANGAN, Co. Dublin (IE)

(73) Assignee: MAIKOLOGY DESIGNATED ACTIVITY COMPANY, Co. Dublin (IE)

(21) Appl. No.: 18/248,515

(22) PCT Filed: Oct. 11, 2021
(86) PCT No.: PCT/EP2021/078075

§ 371 Date: Apr. 10, 2023

(30) Foreign Application Priority Data
Oct. 9, 2020 (GB) 2016102.2

(51) Int. Cl. D06F 58/26; D06F 58/10

(52) U.S. Cl. CPC D06F 58/26; D06F 58/10

(57) ABSTRACT

A solar clothes dryer (1) comprising an outer housing (2); a solar powered air heater (18) in the housing (2), and a drying chamber (6) within the housing (2) to receive heated air from the solar powered air heater (18) wherein the clothes dryer comprises a heat recovery system and/or a solar powered radiator system.

### FIELD

This disclosure relates to a clothes dryer and more particularly to a solar clothes dryer.

### BACKGROUND

Clothes and other items of laundry are generally dried naturally, outdoors or indoors, on clothes lines, clothes horses and the like. However, outdoor drying is weather and season dependent and can be slow or difficult particularly in damp climates while indoor drying can result in damp problems in dwellings and is known to have negative health implications. In addition, the drying of laundry on radiators and the like is unsightly and can be energy inefficient. Accordingly, tumble dryers are widely used to dry laundry. However, tumble dryers consume large amounts of energy, are environmentally unfriendly and can cause damage to fabrics.

Accordingly, various indoor and outdoor devices have been developed aimed at improving clothes drying in all conditions whilst optimising the way in which energy is used to dry the clothes.

PCT Patent Specification No. Wo 2005/084138, European Patent Specification No. 0257712 and European Patent Specification No. 3433412 all describe outdoor solar clothes dryers in which solar power is harnessed to improve the performance of the clothes dryers. European Patent Specification No. 3433412 in particular describes a solar clothes dryer in which air, heated by the sun, is circulated within a drying chamber contained within the clothes dryer to improve drying. Other patent publications in the art include CN111321569 (Guo et al); CN1828169 (Wang); CN203498676 (Jin); CN102168361 (Zhiyong) and JP2014152935 (Suzuki).

Nevertheless, a need always exists for improved solar clothes dryers in which solar gain is further maximised to optimise clothes drying.

An object of the invention is overcome at least some of the problems of the prior art.

### BRIEF SUMMARY OF THE INVENTION

According to a first embodiment of the invention there is provided, as set out in the appended claims, a solar clothes dryer comprising:
an outer housing;
a solar powered air heater in the housing, and
a drying chamber within the housing to receive heated air from the solar powered air heater
wherein the clothes dryer comprises a heat recovery system.

Preferably, the heat recovery system comprises a heat exchanger. More preferably, the heat exchanger is in heat communication with the solar powered air heater.

In one embodiment, the heat exchanger is formed as part of the solar powered air heater. Suitably, the heat exchanger is formed in the outer housing. Preferably, the heat exchanger is formed in a sidewall or top wall of the outer housing.

In one embodiment, the heat exchanger comprises a heated air conduit separated from an exhausted air duct by a heat conductor.

Suitably, the heat conductor comprises a thermally conductive material, for example aluminium.

Preferably, the heated air conduit comprises an air inlet and the exhausted air duct comprises an exhausted air outlet. The air can be fresh air, pre-heated air or solar heated air.

In one embodiment, the solar clothes dryer further comprises an air distribution system.

Preferably, the air distribution system is a solar powered air distribution system.

Suitably, the clothes dryer comprises at least one photovoltaic panel.

In another embodiment, the solar clothes dryer further comprises a solar powered radiator system.

Preferably, the solar powered radiator system comprises
an evacuated tube collector for heating fluid;
a fluid reservoir, for sample a water tank communicable with the evacuated tube collector, and
a radiator connected to the fluid reservoir, the solar powered radiator system being mountable in a solar clothes dryer.

Suitably, the evacuated tube collector comprises a twin-wall having a vacuum, near vacuum or gas defined between the walls.

Advantageously, the reservoir comprises a twin-wall vacuum construction.

Optionally, the reservoir comprises ventilation to prevent pressure build up.

Preferably, the solar clothes dryer further comprises a fluid pump. More preferably, the pump is a solar or battery or hybrid powered pump.

Suitably, the solar powered radiator system is configured to run on demand.

Preferably, the solar powered radiator system is a closed loop system.

Suitably, the radiator is configured to define a clothes hanging rail.

In a further embodiment, the invention also extends to a method for drying clothes comprising:
placing clothes in a solar clothes dryer having a solar powered air heater;
heating air with the solar powered air heater;
drying the clothes with the heated air, and
exhausting the heated air
wherein heat is recovered from the heated air with a heat recovery system before its exhaustion.

Preferably, the heat recovery system comprises a heat exchanger. Suitably, the heat exchanger is in heat communication with the solar powered air heater.

Preferably, the heat exchanger is formed as part of the solar powered air heater. More preferably, the heat exchanger is formed in the outer housing. Most preferably, the heat exchanger is formed in a sidewall or top wall of the outer housing.

Suitably, the heat exchanger comprises a heated air conduit separated from an exhausted air duct by a heat conductor.

Advantageously, the heat conductor comprises aluminium or a thermally conductive material.

Suitably, the heated air conduit comprises a fresh air inlet and the exhausted air duct comprises an exhausted air outlet.

Advantageously, the solar clothes dryer further comprises an air distribution system. Preferably, the air distribution system is a solar powered air distribution system.

Suitably, the clothes dryer comprises at least one photovoltaic panel.

In a further embodiment, the invention also extends to a solar powered radiator system for a solar clothes dryer comprising:
an evacuated tube collector for heating fluid;
a fluid reservoir communicable with the evacuated tube collector, and
a radiator connected to the fluid reservoir, the solar powered radiator system being mountable in a solar clothes dryer.

Preferably, the evacuated tube collector comprises a twin-wall having a vacuum, near vacuum or gas defined between the walls.

Suitably, the reservoir comprises a twin-wall vacuum construction.

Optionally, the reservoir comprises ventilation to prevent pressure build up.

Preferably, the solar powered radiator system further comprises a fluid pump. Preferably, the pump is a solar or battery or hybrid powered pump.

Suitably, the solar powered radiator system is configured to run on demand.

Preferably, the radiator is configured to define a clothes hanging rail.

Suitably, the solar powered radiator system is a closed loop radiator system.

In a further embodiment, the invention extends to a solar clothes dryer comprising an outer housing;
a solar powered air heater in the housing, and
a drying chamber within the housing to receive heated air from the solar powered air heater and a solar powered radiator system as hereinbefore defined.

Preferably, the solar powered radiator system is integral with the solar clothes dryer. More preferably, the solar powered radiator system is formed in the housing. Most preferably, the solar powered radiator system is formed in a sidewall or a top wall of the housing.

Suitably, the solar clothes dryer further comprises a heat recovery system. Preferably, the heat recovery system comprises a heat exchanger. More preferably, the heat exchanger is in heat communication with the solar powered air heater.

In one embodiment, the heat exchanger is formed as part of the solar powered air heater.

Preferably, the heat exchanger is formed in the outer housing. More preferably, the heat exchanger is formed in a sidewall or top wall of the outer housing.

Suitably, the heat exchanger comprises a heated air conduit separated from an exhausted air duct by a heat conductor.

Preferably, the heat conductor comprises aluminium.

Suitably, the heated air conduit comprises a fresh air inlet and the exhausted air duct comprises an exhausted air outlet.

In one embodiment, the solar clothes dryer further comprises an air distribution system. Preferably, the air distribution system is a solar powered air distribution system.

Suitably, the clothes dryer comprises at least one photovoltaic panel.

In another embodiment, the invention also extends to a method for drying clothes comprising:
placing clothes in a solar clothes dryer having a solar powered air heater;
heating air with the solar powered air heater;
drying the clothes with the heated air, and
further drying the clothes with heat from a solar powered radiator system.

Preferably, the solar powered radiator system comprises an evacuated tube collector for heating fluid;
a fluid reservoir communicable with the evacuated tube collector and
a radiator connected to the fluid reservoir, the solar powered radiator system being mountable in the solar clothes dryer.

Preferably, the solar powered radiator system is integral with the solar clothes dryer.

More preferably, the solar powered radiator system is formed in the housing. Most preferably, the solar powered radiator system is formed in a sidewall or a top wall of the housing.

Suitably, in another embodiment the solar clothes dryer comprises an ultra violet (UV) light source and configured to reduce, and/or remove and/or eradicate harmful agents, for example bacteria, on items positioned within the solar clothes dryer. The ability of one or more UV light sources to be located in the apparatus for provision of increased hygiene benefits and/or for performance enhancement.

The heat recovery system employed in the clothes dryers of the invention increases the temperature of the heated air to further optimise drying in the clothes dryer i.e. the heat is increased so that faster and more consistent drying results.

This solar powered radiation system employed in solar clothes dryers of the invention enables faster and/or more consistent drying on demand. The solar powered radiation system therefore acts as a radiator raising the overall temperature of solar clothes dryers and is suitable for use in all solar clothes dryers. More particularly, the solar powered radiation system can be used in conjunction with any type of solar drying clothes dryer and can even be retrofitted to known solar clothes dryers. In use, the solar powered radiation system therefore captures, stores and delivers areas of high heat on demand. By delivering high heat to particular or all areas of the solar dryer, the solar powered radiation system improves clothes drying times and/or consistency. The solar powered radiation system therefore captures solar gain with high efficiency and stores the heat to be used on demand. The solar powered radiation system is also a closed loop heating system resulting in minimal heat losses and controlled use of the heat to ensure efficient drying. As indicated above, the solar powered radiation system can be in-built and/or an additional plug-in for existing solar clothes dryers. As discussed further below, the solar powered radiation system can be powered by standard or off-the-shelf evacuated tube collectors or by evacuated tube collectors formed integrally with or as part of the clothes dryer e.g. within the walls of the solar clothes dryer.

### BRIEF DESCRIPTION OF THE DRAWINGS

The invention will now be described, by way of example only, with reference to the accompanying drawings in which:

FIG. 1 is a side elevation of a solar clothes dryer of the prior art with the generally upward and outward direction of travel of solar heated air through the clothes dryer indicated by the arrows;

FIG. 2 is a side elevation of a first embodiment of a solar clothes dryer of the invention incorporating a heat recovery system to recover heat from high humidity air being exhausted or expelled from the clothes dryer that is used to heat air entering the drying chamber of the clothes dryer with the direction of travel of the fresh heated air and the exhausted air indicated by the arrows;

FIG. 3 is an enlarged cross-sectional view through the double walled sidewall of the clothes dryer showing the inward travelling or rising heated air conduit separated from the outward travelling humid exhausted air duct by a heat conductor in the sidewall to define a heat recovery system in the clothes dryer;

FIG. 4 is a longitudinal cross-sectional view from the front of a second embodiment of a solar clothes dryer of the invention in which the clothes dryer is provided with a solar powered radiator heated by a solar evacuated tube collector;

FIG. 5 is a longitudinal cross-sectional view through the clothes dryer of FIG. 4,

FIG. 6 is an enlarged perspective view from above and one side of a radiator for use in the clothes dryer of FIGS. 4 and 5; and

FIGS. 7 and 8 illustrates the radiator system of FIG. 6 positioned entirely inside a clothes dryer according to another embodiment of the invention.

### DETAILED DESCRIPTION OF THE INVENTION

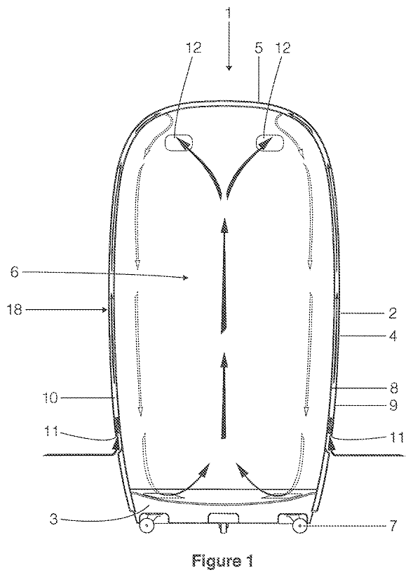

As shown in FIG. 1 of the drawings a solar clothes dryer of the prior art is generally indicated by the reference numeral 1 and is made up of a substantially cylindrical outer housing 2 having a bottom wall 3, a double or twin sidewall 4 upstanding from the bottom wall 3 and a top wall 5 contiguous with the double sidewall 4. Internally, the cylindrical housing 2 defines a clothes drying chamber 6 while, externally, the bottom wall 3 is provided with wheels 7 to enable movement of the clothes dryer 1. The double sidewall 4 is made up of an inner skin or wall 8 and an outer skin or wall 9 separated by a cavity 10. The inner wall 8 can be constructed from a non-transparent heat absorbing material such as polypropylene, polyethylene or polyvinyl chloride while the outer wall 9 can be constructed from a transparent material of low heat absorbance such as polymethylmethacrylate, cellulose acetate butyrate, polycarbonate or polyethylene terephthalate glycol-modified (PETG) so that solar radiation impacting on the inner wall 8 through the outer wall 9 causes air entering the cavity 10 through air inlets 11 to be heated. The inner wall 8, the outer wall 9 and the cavity 10 therefore define a solar powered air heater 18 for heating air to dry laundry in the drying chamber 6. The heated air can then be directed downwards in the drying chamber 6 by an air distribution system (not shown) to then travel rise upwards through the drying chamber 6 in the direction indicated by the arrows. The rising heated air therefore dries clothing within the drying chamber 6 during travel through the drying chamber 6. The humidity laden heated air (exhausted air) then exits the solar clothes dryer 1 through exhaust outlets 12 defined at the top wall 5 of the cylindrical housing 5. Items to be dried can be inserted in and removed from the drying chamber as required through a door (not shown) defined in the sidewall 4. As indicated above, while the solar clothes dryer 1 of FIG. 1 is effective in the drying of laundry, the clothes dryer 1, like all solar clothes dryers, could nevertheless benefit from improvements in exploiting solar gains.

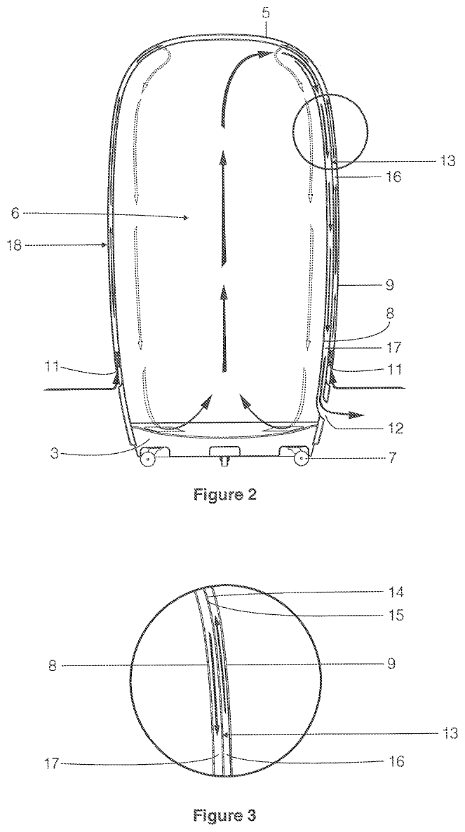

FIGS. 2 and 3 show a first embodiment of a solar clothes dryer 1 of the invention which can be generally similar in construction to the clothes dryer 1 of FIG. 1. Accordingly, like numerals indicate like parts. However, the clothes dryer 1 of the present embodiment is provided with a heat recovery system 13 to recover heat from the high humidity air being exhausted from the clothes dryer 1. The recovered heat can then be used to further heat air entering the drying chamber 6 of the clothes dryer 1. In the context of the present invention the recovery system is to be used specifically with solar clothes dryers. It does not matter the form or type of solar dryer. A feature of the present invention is a change of exhausted airflow through a heat recovery channel. The goal of the invention is to improve the drying performance of a solar clothes dryer by recapturing heat and removing humid air.

More particularly, in the present embodiment, the heat recovery system 13 is in the form of a heat exchanger 14 in heat communication with or formed as part of the solar powered air heater 18. In the present embodiment, the heat exchanger 14 is disposed in the cavity 10 between the inner wall 8 and the outer wall 9 of the double sidewall 4. The heat exchanger 14 is formed from a heat conductor 15 (e.g. aluminium) and is configured within the cavity 10 to define an air tight barrier between an outer air heating conduit 16 and a parallel inner exhaust air duct 17. Fresh air from the fresh air inlet 11 is heated by solar rays passing through the outer wall 9 which impact a heat absorbing material such as polypropylene, polyethylene or polyvinyl chloride disposed on the heat conductor 15. The heated air then travels upwards through the outer air heating conduit 16 into the drying chamber 6 and then travels upwards through the drying chamber 6 towards the top wall 5 to dry laundry as previously described. The heated air accumulates moisture as it travels upwards through the drying chamber 6.

Exhausted moisture laden air then travels downwards through the inner exhaust air duct 17 towards exhausted air outlets 12 which in the present embodiment are disposed towards the bottom wall 3. Accordingly, the exhausted moisture laden air travels downwards in the inner exhaust air duct 17 in an opposite direction to but parallel with the fresh heated air in the outer air heating conduit 16. Simultaneously, the heat conductor 15 of the heat recovery system 13 therefore receives heat from the moisture laden exhausted air and conducts the heat into the outer air heating conduit heat 16 to augment heating from the solar heat absorbing material and further heat the incoming fresh air. As the heart conductor 15 defines an air-tight barrier between the outer air heating conduit 16 and the inner exhaust air duct 17, moisture, dust, lint and the like is not transferred during heat transfer. Accordingly, the heat recovery system serves as a supplementary heat source so that heating efficiency is improved with a consequent improvement in the performance and consistency in use of the clothes dryer 1.

As will be appreciated by those skilled in the art, in other embodiments, the heat recovery system 13 employed in the solar clothes dryer 1 can be positioned in alternative locations in the clothes dryer 1 and can also be configured to form air paths of varying shapes to further enhance heat exchange e.g. labyrinth heat exchangers.

It will also be appreciated by those skilled in the art that the heat recovery system can be employed with any solar clothes dryer to improve its performance while the solar clothes dryer can be a single, double or other multiple sidewall clothes dryer.

The solar clothes dryer 1 of the invention can also be provided with one or more photovoltaic (PV) panels if desired. The PV panels can serve to power clothes dryer batteries, fans and the like for use in driving air distribution systems and the like to direct air movements within the clothes dryer as required.

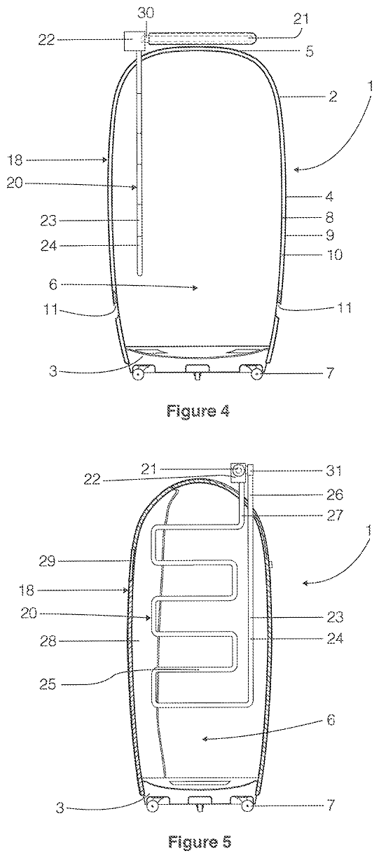

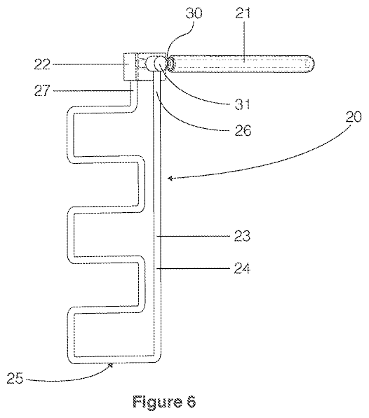

FIGS. 4 to 6 show a second embodiment of a solar clothes dryer 1 of the invention which can be generally similar in construction to the clothes dryer 1 of FIGS. 1 to 3. Accordingly, like numerals indicate like parts. As shown in the drawings, in the present embodiment, the clothes dryer 1 is provided with a solar powered radiator system 20 heated by an externally mounted solar evacuated tube collector 21 so that clothes within the drying chamber 6 can be dried by the solar powered radiator system 20 alone or in combination with the solar heated air provided by the solar powered air heater 18 as previously described. Evacuated tube collectors 21 will be known to those skilled in the art and are generally made up of a twin-wall housing having a vacuum, near vacuum or gas defined between the walls. The vacuum, near vacuum or gas prevents heat loss between the walls and allows high heat to be transferred from the evacuated tube collectors through a heat pipe.

In the present embodiment, the solar clothes dryer 1 is a dual heat source solar clothes dryer 1 employing heated air heated by the solar powered air heater 18 as shown in either FIG. 1 or FIGS. 2 and 3 together with heat from the solar radiator system 20. If desired, in another embodiment, the solar clothes dryer 1 of the present embodiment can also include a heat recovery system 13.

The radiator system 20 is provided with a fluid reservoir 22 connected by a heat transfer pipe 30 to the evacuated tube collector 21 in which fluid, e.g. water, is heated by the evacuated tube collector 21. The reservoir fluid is therefore heated via the heat transfer pipe 30 (or alternative means of transferring heat from the evacuated tube collector 21). The reservoir 22 typically has an inlet and outlet to add or purge fluid as required. The reservoir 22 can also a valve/valves to control pressure within the reservoir 22. In one embodiment, the reservoir 22 may have a twin wall vacuum construction similar to that of a vacuum flask to prevent heat loss. The reservoir 22 may also have ventilation to prevent pressure build up and/or an inlet and outlet for purging and filling the reservoir 22.

The fluid reservoir 22 is in turn connected by a fluid pump 31 to a radiator 23 internally mounted in the drying chamber 6 for drying clothes. The fluid pump 31 can be powered by a dedicated fluid pump battery, mains power or the solar clothes dryer battery employed to drive the air distribution system. The fluid pump 31 can be configured or programmed to run during the drying process, or at software controlled intervals so that fluid can be pumped to the radiator 23 on demand.

The radiator 23 is typically formed from piping 24 shaped and configured to define a hanging rail 25 on which items of laundry can be placed to dry. The radiator 23 is generally positioned in such a way as to interact with the solar heated airflow to maximise drying. The piping 24 in turn is made up of a fluid flow section 26 in which heated fluid flows from the fluid reservoir 22 and a contiguous fluid return section 27 in which cooler fluid is returned to the fluid reservoir 22 for re-heating.

The cylindrical housing 2 of the solar clothes dryer 1 is provided with a door 28 provided with a handle 29 for accessing the drying chamber 6. The solar powered radiator system 20 is a closed loop heating system which therefore results in minimal heat losses and controlled use of the heat to ensure efficient drying.

In use, heat from the evacuated tube collector 21 is transferred to the fluid reservoir 22 via the heat transfer pipe 30. The fluid pump 31 then circulates the fluid from the fluid reservoir 22 around piping 24 of the radiator 23 within the drying chamber 6. The hanging rail 25 defined by the piping 24 therefore acts as a heated hanging rail 25 for drying and/or serves to transfer heat into particular areas of the drying chamber 6 in which the radiator 23 is mounted for targeted drying. Heat transfer can be by way of convection, conduction or radiation to the clothes to improve drying The hanging rail 25 can also allow for garments to be hung directly onto the hanging rail 25 if desired.

As with the embodiment of FIGS. 2 and 3, the solar clothes dryer 1 of the present embodiment can also be provided with one or more photovoltaic (PV) panels to power clothes dryer batteries, fans and the like.

In another embodiment of the invention, the solar powered radiator system 20 can be integral with the clothes dryer 1 or a suitable structural element of the clothes dryer 1. For example, the radiator system 20 can be integral with or be formed as a section or part of the sidewall 4 or top wall 5 of the solar clothes dryer 1 where the sidewall 4 can be a single wall, double wall, triple or other multiple layered wall as previously described. More particularly, the evacuated tube collector 21 can be formed integrally with or as part of the sidewall 4 or top wall 5. In this embodiment, the outer wall 9 of the sidewall 9 is a clear wall formed from a material such as polycarbonate or glass and the inner wall 8 is a black or other suitable surface employing a material or coating to capture solar gain. The required vacuum, near vacuum or gas is provided between the inner and outer walls 9 to prevent heat loss. The inner and outer walls 8,9 can include a getter to maintain the vacuum if required. In addition, a vacuum pump can be in communication with the vacuum or near vacuum to maintain the vacuum or near vacuum.

As with the embodiment of FIGS. 4 to 6, heat captured by the inner wall 8 is transferred into a fluid reservoir 22 by way of conduction, convection and/or radiation via a heat transfer pipe such as a copper heat pipe.

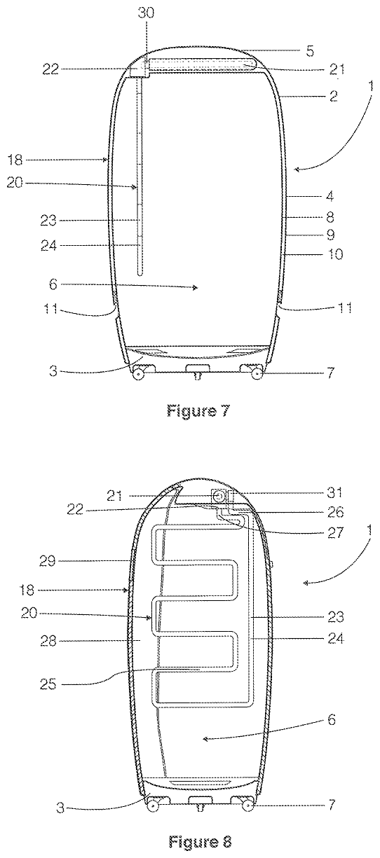

FIGS. 7 and 8 illustrates the radiator system of FIG. 6 positioned entirely inside a clothes dryer as hereinbefore described.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A solar clothes dryer comprising:
an outer housing;
a solar powered air heater in the housing, and
a drying chamber within the housing to receive heated air from the solar powered air heater
wherein the clothes dryer comprises a heat recovery system.

2. A solar clothes dryer as claimed in claim 1 wherein the heat recovery system comprises a heat exchanger.

3. A solar clothes dryer as claimed in claim 2 wherein the heat exchanger is in heat communication with the solar powered air heater.

4. A solar clothes dryer as claimed in claim 3 wherein the heat exchanger is formed as part of the solar powered air heater.

5. A solar clothes dryer as claimed in claim 4 wherein the heat exchanger is formed in the outer housing.

6. A solar clothes dryer as claimed in claim 5 wherein the heat exchanger is formed in a sidewall or top wall of the outer housing.

7. A solar clothes dryer as claimed in any of claims 4 to 6 wherein the heat exchanger comprises a heated air conduit separated from an exhausted air duct by a heat conductor.

8. A solar clothes dryer as claimed in claim 7 wherein the heat conductor comprises aluminium.

9. A solar clothes dryer as claimed in claim 7 or claim 8 wherein the heated air conduit comprises a fresh air inlet.

10. A solar clothes dryer as claimed in any of claims 7 to 9 wherein the exhausted air duct comprises an exhausted air outlet.

11. A solar clothes dryer as claimed in any of claims 1 to 10 further comprising an air distribution system.

12. A solar clothes dryer as claimed in claim 11 wherein the air distribution system is a solar powered air distribution system.

13. A solar clothes dryer as claimed in any of claims 1 to 12 wherein the clothes dryer comprises at least one photovoltaic panel.

14. A solar clothes dryer as claimed in any of claims 1 to 13 comprising a ultra violet light source and configured to reduce, and/or remove and/or eradicate harmful agents, for example bacteria, on items positioned within the solar clothes dryer.

15. A solar clothes dryer as claimed in any of claims 1 to 14 wherein the solar clothes dryer further comprises a solar powered radiator system.

16. A solar clothes dryer as claimed in claim 15 wherein the solar powered radiator system comprises:
an evacuated tube collector for heating fluid;
a fluid reservoir communicable with the evacuated tube collector, and
a radiator connected to the fluid reservoir, the solar powered radiator system being mountable in a solar clothes dryer.

17. A solar clothes dryer as claimed in claim 16 wherein the evacuated tube collector comprises a twin-wall having a vacuum, near vacuum or gas defined between the walls.

18. A solar clothes dryer as claimed in claim 16 or claim 17 wherein the reservoir comprises a twin-wall vacuum construction.

19. A solar clothes dryer as claimed in any of claims 15 to 18 wherein the reservoir comprises ventilation to prevent pressure build up.

20. A solar clothes dryer as claimed in any of claims 15 to 19 further comprising a fluid pump, and/or the pump is a solar powered pump.

21. A solar clothes dryer as claimed in any of claims 15 to 20 wherein the solar powered radiator system is configured to run on demand.

22. A solar clothes dryer as claimed in any of claims 15 to 21 wherein the solar powered radiator system is a closed loop system.

23. A method for drying clothes comprising:
placing clothes in a solar clothes dryer having a solar powered air heater;
heating air with the solar powered air heater;
drying the clothes with the heated air, and
exhausting the heated air
wherein heat is recovered from the heated air with a heat recovery system before its exhaustion.
